(19) United States
(12) Patent Application Publication
(10) Pub. No.: US 2009/0133429 A1
(43) Pub. Date: May 28, 2009

(54) Method and Control of a Thermic Processing Unit and Thermic Processing Unit

(76) Inventor: Tage Petersen, Vojens (DK)

Correspondence Address: JAMES C. WRAY, 1493 CHAIN BRIDGE ROAD, SUITE 300, MCLEAN, VA, 22101, US

(21) Appl. No.: 11/992,460

(22) PCT Filed: Oct. 4, 2006
(86) PCT No.: PCT/DK2006/000549

§ 371 Date: Jun. 9, 2008

(30) Foreign Application Priority Data
Oct. 7, 2005 (DK) PA 2005 01405

(51) Int. Cl. B01F 15/06; A23G 9/12

(52) U.S. Cl. 62/342

(57) ABSTRACT

There is disclosed a method for controlling an ice cream freezer where a scraper shaft is driven with variable rotational speed for providing a desired working of an ice cream. Moreover, there is disclosed an ice cream freezer that may utilize such a control and which has means enabling control according to the above principle.

### FIELD OF THE INVENTION

The present invention concerns a method for controlling a thermal treatment unit, where a rotating stirrer shaft is driven at a variable rotational speed for establishing a desired working of a viscous product, preferably an ice cream freezer, where a scraper shaft is driven at a variable rotational speed for providing a desired working of an ice cream. The invention furthermore concerns a thermal treatment unit with a treatment chamber provided with temperature control, with a motor driven, rotating stirrer shaft mounted therein which is provided with a number of stirrer means providing a certain mixing due to their movement through a viscous product, the unit including a supply of the product in relatively fluid form, as well as a control unit for controlling the temperature. The treatment unit is preferably an ice cream freezer with a freezer tube and a scraper shaft.

The invention has appeared in connection with ice cream freezers and will thus be explained in connection with this technology in the present application. However, the invention may be applied to any such thermal treatment units where a viscous product is stirred for providing admixing, e.g. with air or other ingredients, e.g. water. The method and the apparatus according to the invention may e.g. also be used for the pre-treating of freeze-dried coffee and tea.

### BACKGROUND OF THE INVENTION

A continuous ice cream freezer is in principle a scraper heat exchanger in which a fluid mass (called ice mixture) is cooled and partly frozen at the same time as stirring and admixing of air are effected, often with air in almost as large amounts as the fluid mass so that the finished product (ice cream) is a highly viscous foam.

The scraper heat exchanger is most frequently designed as a pipe (called a freezer tube) which is cooled externally and with a motorised rotating shaft (called scraper shaft) inside. On the rotating shaft is mounted a number of knives that scrape the frozen ice off the pipe as well as producing a certain mixing action due to their movement through the product. At the entrance to the tube, the ice mixture is relatively light-fluid, but as it moves through the tube and is increasingly cooled, it becomes highly viscous.

Control of the cooling may be performed in different ways, but a widely used principle in automatic ice cream freezers is the so-called “viscosity control”. By this form of control, the power consumption of the motor driving the scraper shaft is measured and compared with a reference value. If the power actually used is less than the reference, cooling is intensified. Thereby is produced a colder ice which thus also has a higher viscosity, thereby causing a higher power consumption in the motor. If the power actually consumed is greater than the reference, cooling is reduced correspondingly. In that way a unequivocal control is attained since the viscosity of ice cream is an unequivocal function of the temperature, cf. the example below.

Viscosity control may thereby be used for achieving a real ice cream temperature control due to the unequivocal relationship between temperature and viscosity. It is noted that hereby control is not performed according to the physical viscosity of the ice cream, but according to the absorbed motor power. However, the term viscosity is frequently used for the measured power, which is often measured in percentages instead of the physical viscosity which is measured in Pa*s. This is illustrated in FIG. 2.

For example, from the description of U.S. Pat. No. 6,553,779 there is known an ice cream freezer with freezer tube and scraper shaft for working the viscous ice cream provided in the ice cream freezer. There is disclosed a traditional control with a regulating system based on measuring pressure and temperature. This provides uncertainty with regard to the attained viscosity and working of the product.

The above considerations are, however, all based on the fact that the scraper shaft is rotating with constant speed. If one desires to make the speed variable, e.g. by driving the motor with a frequency converter or other type of variable control, the situation complicates as the power typically varies with the speed at a fixed temperature of the ice cream, as shown on FIG. 3.

Operationally, this is a problem since the operator wants to set a certain product viscosity (equivalent with the ice cream temperature), and does not want this viscosity to change by changing the scraper shaft speed. Conversely, the operator desires to be able to vary the scraper shaft speed, as there is an optimal working for most types of ice cream.

If working too hard (high speed) there may be a risk of churning lumps of fat. If working too light (low speed), this may result in poor mixing.

Thus there is a need for a control that may “translate” the operator's desire for a certain product viscosity and a certain working for controlling the cooling and setting the scraper shaft speed.

If the operator enters a new value for the working, it is desirable that the control sets the scraper shaft speed and the cooling in such a way that the product viscosity is unchanged, even if the scraper shaft speed and thus the motor power are changed.

### OBJECT OF THE INVENTION

It is thus the purpose of the invention to indicate a method whereby the scraper shaft speed and the cooling are set on the basis of desired product viscosity and desired working. It is also the purpose to indicate an ice cream freezer with a control that enables the scraper shaft speed and the cooling to be set on the basis of desired product viscosity and desired working.

### DESCRIPTION OF THE INVENTION

According to the present invention, this is achieved with a method which is peculiar by the steps of:
A: determining the relationship between working and the torque of a motor for driving the stirrer shaft;
B: determining the relationship between viscosity and the temperature;
C: determining the relationship between the torque of the motor and the rotational speed of the stirrer shaft at different temperatures of the viscous product;
D: determining the relationship between the torque of the motor and the rotational speed of the stirrer shaft at different loads on the motor;
E: determining desired viscosity and desired working;
F: calculating the torque of the motor based on the relationships determined in steps A—E, as a rotational speed for the stirrer shaft is calculated and an adjustment of the temperature is established for providing the correct torque of the motor.

In an ice cream freezer, a scraper shaft is used in step A, and ice cream temperatures are measured, and the temperature control established in step F will be a cooling.

The apparatus according to the invention is peculiar in that the control unit is arranged for:
A: determining the relationship between working and the torque of a motor for driving the stirrer shaft;
B: determining the relationship between viscosity and the temperature;
C: determining the relationship between the torque of the motor and the rotational speed of the stirrer shaft at different ice cream temperatures for the viscous product;
D: determining the relationship between the torque of the motor and the rotational speed of the stirrer shaft at different loads on the motor;
E: determining desired viscosity and desired working;
F: calculating the torque of the motor based on the relationships determined in steps A-E, as a rotational speed for the stirrer shaft is calculated and an adjustment of the temperature is established for providing the correct torque of the motor.

In an ice cream freezer, a scraper shaft disposed in a freezer tube will be used, provided with knives scraping the frozen ice off the freezer tube and providing the mixing action.

By performing a number of measurements at various scraper shaft speeds and ice cream temperatures, an overview of the relationships between torque and scraper shaft speed can be achieved, enabling a control principle that contributes to fulfil the purpose of the invention.

Here, it appears that a relatively simple relationship can be established between the scraper shaft speed and the torque required to rotate the scraper shaft. Typically, the relationship is very close to linear, as shown on the graph in FIG. 4.

The disposition of the individual lines for ice cream temperatures may of course be varied for different kinds of ice cream, but the fundamental relationship is maintained, and it relatively easy to set up a system of equations approximating the real behaviour.

When analyzing ice cream produced under varying conditions, surprisingly it appears that the working, measured in terms of fat produced by churning, is in practice just a function of the torque used for driving the scraper shaft.

If compared with the torque characteristic of the motor, e.g. for a frequency converter driven electric motor, a relationship as shown on FIG. 5 is achieved.

The possible operational range lies below the curve of maximum motor torque. Since the viscosity of the ice cream is a function of the temperature, instead of the temperatures indicated on the graph a viscosity may be indicated (which is not necessarily proportional with the temperature but may be defined as an arbitrary unequivocal function of the temperature). For example, the viscosity may be indicated in percent as shown on FIG. 6.

Since the equations for the viscosity are known, and the working is a function of the torque of the motor, a control may now be established where the operator can enter a viscosity and a working.

The PLC of the ice cream freezer may now calculate the intersection point between the two curves. This may e.g. occur as indicated in FIG. 6 by the black dot at the intersection between 40% viscosity and XX % motor torque (=XX % working).

The speed may thus be calculated and set, whereafter the cooling can be adjusted until the desired torque is attained.

If a new value for the working is entered, a new point of intersection is calculated. In FIG. 7 with a white dot is thus shown, as an example, the entering of YY % motor torque, still at 40% viscosity.

Since YY is greater than XX, this results in calculating a higher speed and at the same time a greater desired torque. The speed may be set on the frequency converter, after which the desired new torque may be attained by adjusting the cooling.

The change in the setpoint may of course also be divided into lesser steps in order not to produce instability by adjusting two parameters at once; this does not alter the basic principle.

According to the present invention, there is thus achieved a control principle for an ice cream freezer for controlling cooling and scraper shaft speed based on two sets of curves: One set for the relationship between motor torque and scraper shaft speed at different loads on the motor, and one set for the relationship between motor torque and scraper shaft speed at different ice cream temperatures.

The operator only enters two values during operation of the machine:
The desired product viscosity (stiffness).
The desired working.

Based on the desired stiffness, the PLC/control unit of the apparatus calculates the associated temperature curve as the temperature is a pre-defined, unequivocal function of the stiffness. This function does not need to be linear but may be defined according to wish, depending on what is considered practical.

Based on the desired working, the machine calculates the associated motor torque curve as the working is a pre-defined, unequivocal function of the motor torque. This function does not need to be linear but may be defined according to wish, depending on what is considered practical.

By calculating the intersection point between the temperature curve and the motor torque curve, the machine finds the correct scraper shaft speed and sets it. The cooling is adjusted in accordance therewith until the correct motor torque is attained.

Control may be performed by the working being calculated as a linear function of the motor torque.

Control may further be performed by the stiffness being calculated as a linear function of the product temperature.

Control may furthermore be performed by not making changes in setpoint in one step but by dividing it into lesser steps, where each step is performed only as the machine is stable in the previous step.

### DESCRIPTION OF THE DRAWING

FIG. 1 shows a schematic view of an ice cream freezer according to the invention controlled by a method according to the invention;

FIG. 2 shows a diagram illustrating relationship between temperature and viscosity for ice cream;

FIG. 3 shows a diagram illustrating the influence of rotational speed of the scraper shaft on the relationship between ice cream temperature and motor torque;

FIG. 4 shows a diagram illustrating the relationship between rotational speed of the scraper shaft and motor torque at different temperatures of the ice cream;

FIG. 5 shows a diagram corresponding to FIG. 4 where the motor torque characteristic is inserted;

FIG. 6 shows a diagram corresponding to FIG. 5 in which the viscosity of the ice cream is indicated instead of temperature curves; and

FIG. 7 shows a diagram corresponding to FIG. 6 with illustration of a further motor torque curve.

### DETAILED DESCRIPTION OF THE INVENTION

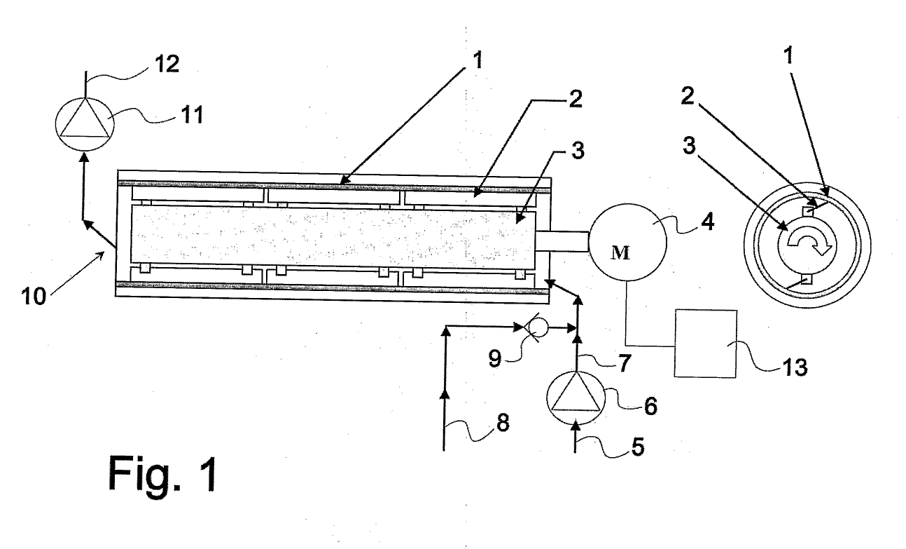

In FIG. 1 is shown a freezer tube 1 in which is provided a knife 2 which scrapes frozen ice off the tube and partly provides admixing of air due to their movement through the product. The knives are therefore provided on a scraper shaft 3 which is driven by a motor 4 for establishing the rotational movement.

A raw mixture 5 is introduced by means of a pump 6 via a pipe 7 to the freezer tube 1. In the pipe 7 air 8 is supplied via a check valve 9 into the raw mixture pumped in.

The freezer tube 1 has an outlet 10 which is connected with a pump 11 to pump out air admixed ice cream 12 from the freezer pipe.

The shown apparatus is connected to a control unit indicated by 13. In principle, the control unit is based on a PLC and connected with relevant sensors (not shown) in the apparatus and provided with algorithms in order to perform the required calculations.

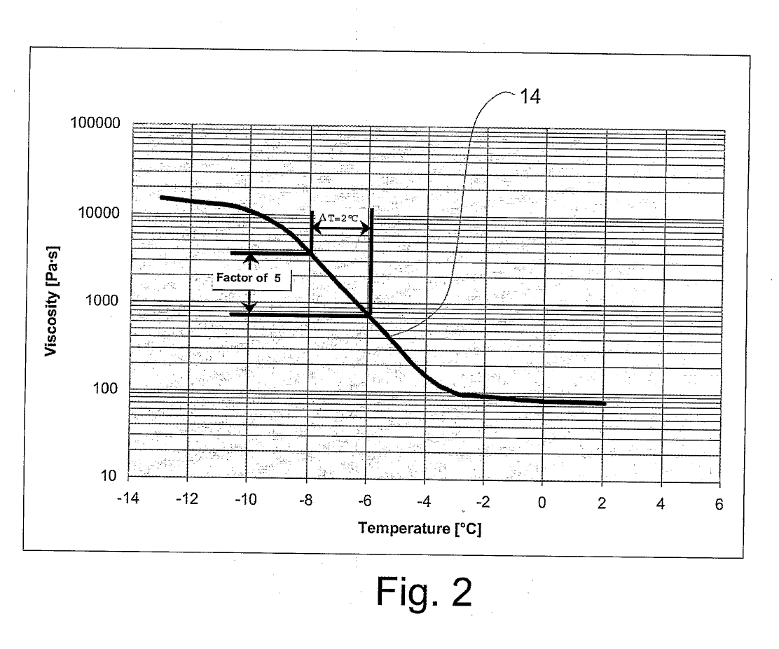

FIG. 2 shows a coordinate system, where the temperature in the ice cream is shown as abscissa, and where viscosity expressed by Pa*s is indicated as ordinate. It appears here that a curve 14 shows the viscosity of the ice cream as an unequivocal function of the temperature.

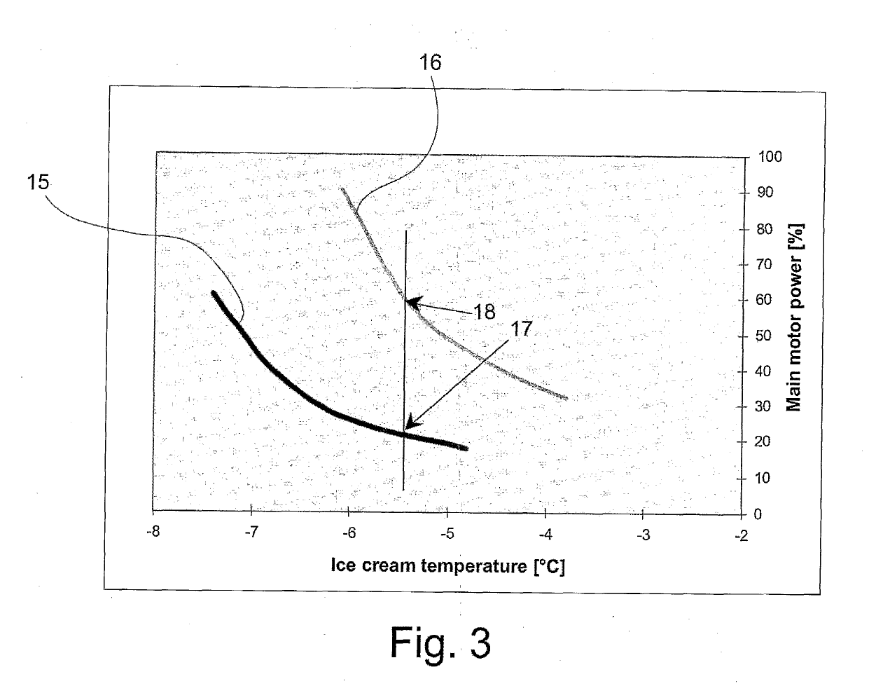

FIG. 3 shows a first curve and a second curve, indicating rotational speeds of the scraper shaft of 200 rpm and 400 rpm, respectively. This illustrates that in points 17 and 18, having the same temperature but different speeds, there will be a need for different motor power.

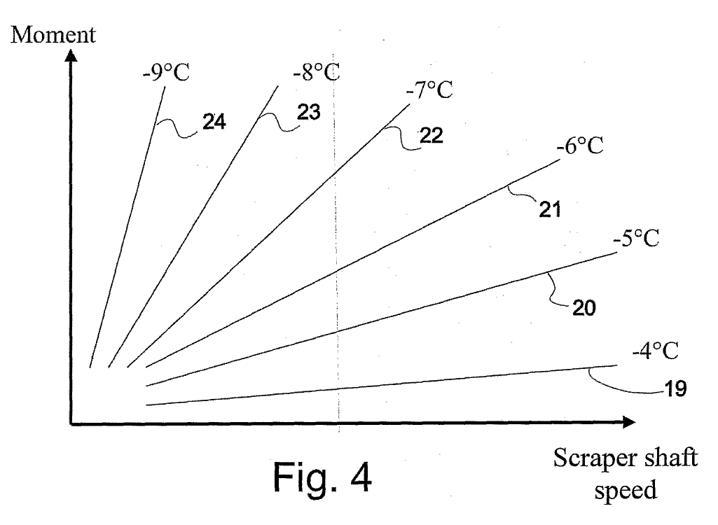

FIG. 4 shows the result achieved by making a number of measurements at different scraper shaft speeds and ice cream temperatures. Here, it appears that a relatively simple relationship can be established between the scraper shaft speed and the torque required to rotate the scraper shaft at different ice cream temperatures. The disposition of the individual curve lines 19, 20, 21, 22, 23 and 24 may vary for different types of ice cream. However, the fundamental relationship is maintained.

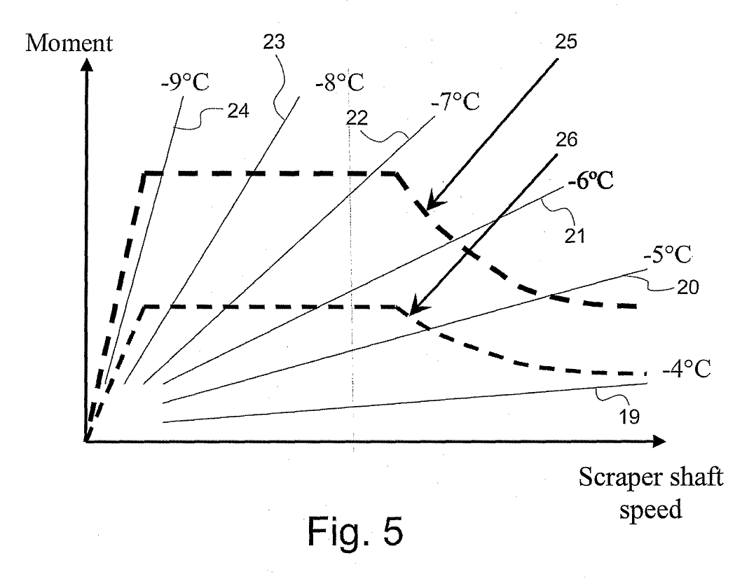

As mentioned, surprisingly it appears that the working, measured in terms of fat produced by churning, in practice is just a function of the torque used for driving the scraper shaft When the curves illustrated in FIG. 2 are compared with a torque characteristic for a motor, the diagram shown in FIG. 5 is achieved. The curves 19-24 are here compared with a curve 25 for maximum motor torque and a curve 26 for XX % of the maximum motor torque.

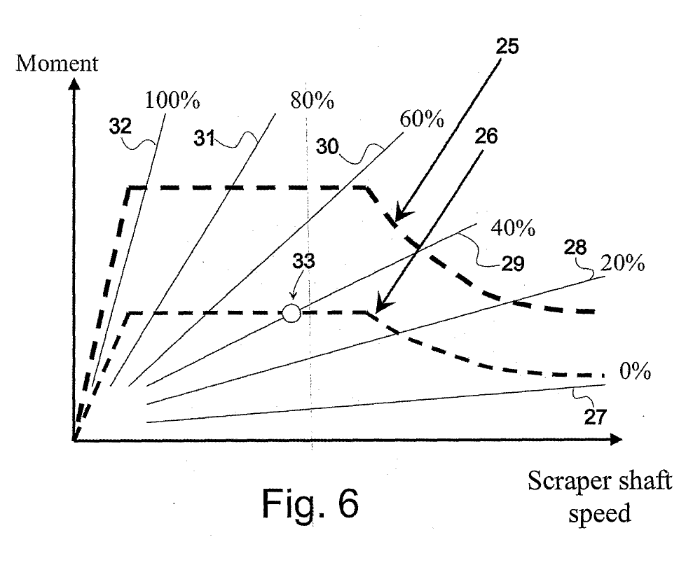

In FIG. 6, temperature curves 19-24 are transformed to viscosity curves 27-32, respectively. The viscosity, which is not necessarily proportional to the temperature, is thus defined as an arbitrary percentage from 0 to 100%.

It now appears that an intersection point 33 between the curve 29 for 40% viscosity and the curve 26 for motor torque of XX % can be calculated by the control unit (PLC) of the ice cream freezer. The speed may thus be calculated and set, whereafter it is possible to set the cooling until the desired torque is attained.

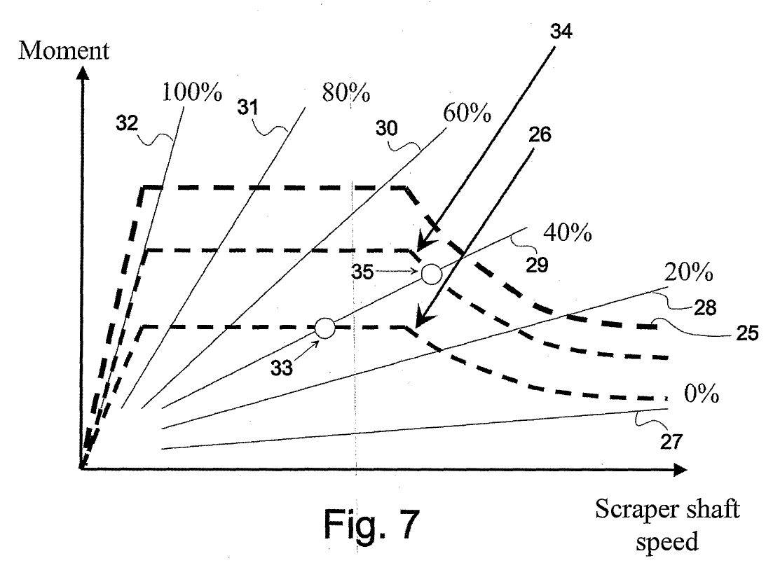

FIG. 7 corresponds to FIG. 6 but contains a further curve 34 providing a higher motor torque of YY % of maximum motor torque than the XX % of maximum motor torque indicated by the curve 26. Here, there is an intersection point 35 between the curve 34 and the curve 29 for 40% viscosity. Since YY % is greater than XX %, this results in calculating a higher speed and at the same time a greater desired torque. Now it is possible to set the speed of a frequency converter for motor control. Then cooling may be adjusted so that a desired torque is achieved.

It is to be noted that the change in setpoint can be divided into lesser steps so that no instability occurs when adjusting two parameters at once.

1. A method for controlling a thermal treatment unit, where a rotating stirrer shaft is driven at a variable rotational speed for establishing a desired working of a viscous product, wherein the steps for
A: determining the relationship between the working and the torque of a motor for driving the stirrer shaft;
B: determining the relationship between viscosity and the temperature;
C: determining the relationship between the torque of the motor and the rotational speed of the stirrer shaft at different temperatures of the viscous product;
D: determining the relationship between the torque of the motor and the rotational speed of the stirrer shaft at different loads on the motor;
E: determining desired viscosity and desired working;
F: calculating the torque of the motor based on the relationships determined in steps A-E, as a rotational speed for the stirrer shaft is calculated and an adjustment of the temperature is established for providing the correct torque of the motor.

2. A method according to claim 1, wherein the working is a function of the torque of the motor only.

3. A method according to claim 1, wherein the viscosity is a function of the temperature only.

4. A method according to claim 1, wherein the torque of the motor is a function of the rotational speed of the stirrer shaft only at a given product temperature.

5. A method according to claim 1, wherein the calculation made in step E is performed stepwise, as each step is performed only when stability has been established in a preceding step.

6. A method according to claim 1, wherein the motor is powered by a frequency converter for establishing the variable rotational speed.

7. A method according to claim 1, wherein the viscosity is defined as an arbitrary parameter corresponding to the temperature of the product, indicated as a percentage that may vary between 0% and 100%.

8. A method according to claim 1, wherein the thermal treatment unit is selected as an ice cream freezer, that the rotating stirrer shaft is selected as a scraper shaft and that the viscous product is selected as an ice cream.

9. A method according to claim 8, wherein the scraper shaft is provided with knives so that frozen ice is scraped off the inner side of a freezer tube.

10. A method according to claim 8, wherein the working is measured in terms of fat produced by churning.

11. A thermal treatment unit with a treatment chamber provided with temperature control, with a motor driven, rotating stirrer shaft mounted therein which is provided with a number of stirrer means providing a certain mixing due to their movement through a viscous product, the unit including a supply of the product in relatively fluid form, as well as a control unit for controlling the temperature, wherein the control unit is adapted for
A: determining the relationship between working and the torque of a motor for driving the stirrer shaft;
B: determining the relationship between viscosity and the temperature;
C: determining the relationship between the torque of the motor and the rotational speed of the stirrer shaft at different ice cream temperatures for the viscous product;
D: determining the relationship between the torque of the motor and the rotational speed of the stirrer shaft at different loads on the motor;
E: determining desired viscosity and desired working;
F: calculating the torque of the motor based on the relationships determined in steps A-E, as a rotational speed for the stirrer shaft is calculated and an adjustment of the temperature is established for providing the correct torque of the motor.

12. A thermal treatment unit according to claim 11, wherein it includes an ice cream freezer with a freezer tube in which a scraper shaft with knives is mounted, the knives scraping frozen ice off the freezer tube and performing the mixing.
